(19) United States
(12) Patent Application Publication
(10) Pub. No.: US 2010/0262686 A1
(43) Pub. Date: Oct. 14, 2010

(54) ONLINE BUSINESS COMMUNITY WEBSITE

(75) Inventors: Warren Adelman, Scottsdale, AZ (US); Michael Chadwick, Chandler, AZ (US); Nate Curran, Phoenix, AZ (US); Jason Winders, Cedar Rapids, IA (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/820,964

(22) Filed: Jun. 22, 2010

Related U.S. Application Data
(62) Division of application No. 11/946,634, filed on Nov. 28, 2007.

(51) Int. Cl. G06F 15/16; H04L 9/32

(52) U.S. Cl. 709/223; 726/5

(57) ABSTRACT

Systems and methods of the present invention allow for providing and managing an online business community. An exemplary system may comprise at least one Hosting Server maintained by a Hosting Entity; a Community Website accessible to a plurality of Clients and hosted on said at least one Hosting Server; a Resource Database storing a plurality of Content, wherein at least some of said Resources are generated by a Member; a Directory Database storing a plurality of Member Information; and a Network communicatively coupling said Hosting Server, said Community Website, said plurality of Clients, said Resource Database, and said Directory Database.

### CROSS REFERENCE TO RELATED PATENT APPLICATIONS

The present application is a divisional of U.S. patent application Ser. No. 11/946,634, “An Online Business Community,” filed Nov. 28, 2007, which is incorporated hereby in its entirety by reference.

The present application also is related to the following previously-filed patent applications, all assigned to The Go Daddy Group, Inc., and incorporated hereby in their entirety by reference: U.S. patent application Ser. No. 11/946,682, “Sub-Communities within an Online Business Community,” filed Nov. 28, 2007; and U.S. patent application Ser. No. 11/946,701, “Designating Membership in an Online Business Community,” filed Nov. 28, 2007.

The present application also is related to the following patent applications concurrently filed herewith, all assigned to The Go Daddy Group, Inc., and incorporated hereby in their entirety by reference: U.S. patent application Ser. No. ______, “Systems for Providing an Online Business Community;” and U.S. patent application Ser. No. ______, “Methods for Providing an Online Business Community.”

### FIELD OF THE INVENTION

The present inventions generally relate to the field of online communities and, more specifically, systems and methods for providing and managing an online business community, systems and methods for providing and managing sub-communities within an online business community, and systems and methods for designating membership in an online business community.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding webpages on the Internet is generally known as the World Wide Web (WWW) or simply the Web.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other, e.g. 64.202.167.32. The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon, for example 2EDC:BA98:0332:0000:CF8A:000C:2154:7313.

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Some Internet businesses, typically those that are larger and more sophisticated, may provide their own hardware, software, and connections to the Internet. But many Internet businesses either do not have the resources available or do not want to create and maintain the infrastructure necessary to host their own websites. To assist such businesses, hosting companies exist that offer website hosting services. These hosting providers typically provide the hardware, software, and electronic communication means necessary to connect multiple websites to the Internet. A single hosting provider may literally host thousands of websites on one or more hosting servers.

For Internet users and businesses alike, the Internet continues to be increasingly valuable. More people use the Web for everyday tasks, from shopping, banking, and paying bills to consuming media and entertainment. E-commerce is growing, with businesses delivering more services and content across the Internet, communicating and collaborating online, and inventing new ways to connect with each other.

Multimedia websites are prevalent on the Web that offer and sell goods and services to individuals and organizations. Such websites allow individuals and businesses to share their information with a large number of Internet users. Many products and services are offered for sale on the Internet, thus elevating the Internet to an essential tool of commerce. Internet businesses, whether large corporations or individuals, are rapidly creating websites to take advantage of the growing number of customers using the Internet and customers' increasing willingness to purchase goods and services over the Web. Websites created by Internet businesses may be reached by millions of Internet-savvy customers, thereby allowing businesses to offer their products and services to a very large pool of potential customers.

Applicant has noticed that presently-existing methods of conducting online business, however, do not permit businesses and potential customers alike to interact in one place to share business-related resources; advertise, buy, and sell goods and services; interact; hold discussions; and network. For the foregoing reasons, there is a need for the online business communities and related functionality as described herein.

### SUMMARY OF THE INVENTION

The limitations cited above and others are substantially overcome through the systems and methods disclosed herein, which allow for providing and managing an online business community.

In an example embodiment, a Hosting Entity may maintain a Hosting Server on which a Community Website may be hosted. Via the Community Website (that may be password protected), a plurality of Members may access a Resource Center, a Directory, a Forum, and/or a Business Portal. The Resource Center may provide Members with a plurality of Content including, but not limited to, articles, documents, links, images, text files, audio files, video files, multimedia files, and/or streaming data, some of which may be provided to the Resource Center by Members. The Directory may include Business Profiles and Individual Profiles, some being generated by Members. The Resource Center and/or Directory also may provide a Comment System, a Rating System, a Flag System, a Search Tool, an Advertisement Service, a Buy/Sell tool, or any combination thereof. The Community Website also may provide a Forum capable of being written to and read by Members, a Business Portal, which allows Members to manage Business Tools, and a Partnership Tool, which allows Members to form partnerships. The online business community also may comprise a Content Management System (that may reside on the Hosting Server) having the ability to manage content on said Community Website.

An exemplary system for providing and managing an online business community may comprise at least one Hosting Server maintained by a Hosting Entity; a Community Website accessible to a plurality of Clients, said Community Website hosted on said at least one Hosting Server; a Resource Database storing a plurality of Content, wherein at least some of said Resources are generated by a Member; a Directory Database storing a plurality of Member Information; and a Network communicatively coupling said Hosting Server, said Community Website, said plurality of Clients, said Resource Database, and said Directory Database.

An exemplary method of providing and managing an online business community may comprise the steps of: providing a Community Website accessible to a plurality of Members via a Network; hosting said Community Website on at least one Hosting Server; enabling said plurality of Members to share a plurality of Business-Related Information on said Community Website; monitoring said plurality of Business-Related Information for an Inappropriate Material; and removing said Inappropriate Material from said Community Website.

An exemplary system for providing and managing sub-communities within an online business community may comprise an Online Business Community having a Community Website hosted on at least one Hosting Server, said at least one Hosting Server communicatively coupled to a Network; a Homepage on said Community Website accessible to a plurality of Members via said Network; and a plurality of Groups accessible to said plurality of Members via said Homepage, wherein each of said Groups relates to a subject.

An exemplary method of providing and managing sub-communities within an online business community may comprise the steps of: providing a Community Website for an Online Business Community accessible to a plurality of Members via a Network; hosting said Community Website on at least one Hosting Server; and enabling said plurality of Members to generate and manage a plurality of Groups on said Community Website.

An exemplary system for designating membership in an online business community may comprise means for designating a plurality of Members as participants in an Online Business Community; and means for providing each of said plurality of Members with a Membership Designator.

An exemplary method for designating membership in an online business community may comprise the steps of: designating a plurality of Members as participants in an Online Business Community; and providing each of said plurality of Members with a Membership Designator.

The above features and advantages of the present invention will be better understood from the following detailed description taken in conjunction with the accompanying drawings.

### BRIEF DESCRIPTION OF THE DRAWINGS

FIG. 1 illustrates a possible embodiment of a system for providing and managing an online business community.

FIG. 2 illustrates a possible embodiment of a system for providing and managing an online business community.

FIG. 3 illustrates a possible embodiment of a Resource Center.

FIG. 4 illustrates a possible embodiment of a Directory.

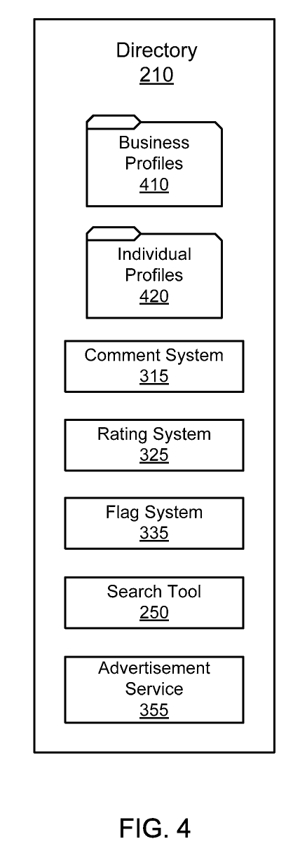

FIG. 5 illustrates a possible embodiment of a system for providing and managing an online business community.

FIG. 6 illustrates a possible embodiment of a Resource Center Webpage.

FIG. 7 illustrates a possible embodiment of a Directory Webpage.

FIG. 8 illustrates a possible embodiment of a system for providing and managing an online business community.

FIG. 9 illustrates a possible embodiment of a system for providing and managing an online business community.

FIG. 10 illustrates possible embodiments of a Hosting Entity.

FIG. 11 illustrates possible embodiments of a plurality of Content.

FIG. 12 illustrates possible embodiments of a Client.

FIG. 13 illustrates possible embodiments of a Network.

FIG. 14 is a flow diagram illustrating a possible embodiment of a method for providing and managing an online business community.

FIG. 15 is a flow diagram illustrating a possible embodiment of a method for providing and managing an online business community.

FIG. 16 illustrates a possible embodiment of a system for providing and managing sub-communities within an online business community.

FIG. 17 illustrates a possible embodiment of a system for providing and managing sub-communities within an online business community.

FIG. 18 illustrates a possible embodiment of a Group Resource Center.

FIG. 19 illustrates a possible embodiment of a Group Directory.

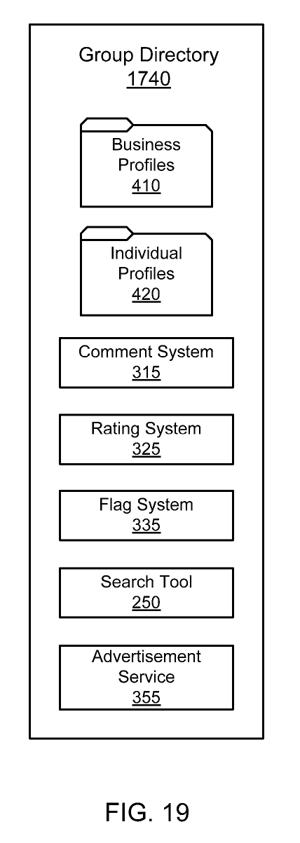

FIG. 20 is a flow diagram illustrating a possible embodiment of a method for providing and managing sub-communities within an online business community.

FIG. 21 illustrates a possible embodiment of a system for designating membership in an online business community.

FIG. 22 is a flow diagram illustrating a possible embodiment of a method for designating membership in an online business community.

FIG. 23 is a flow diagram illustrating a possible embodiment of a method for designating membership in an online business community.

### DETAILED DESCRIPTION

The present inventions will now be discussed in detail with regard to the attached drawing figures which were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A System for Providing and Managing an Online Business Community

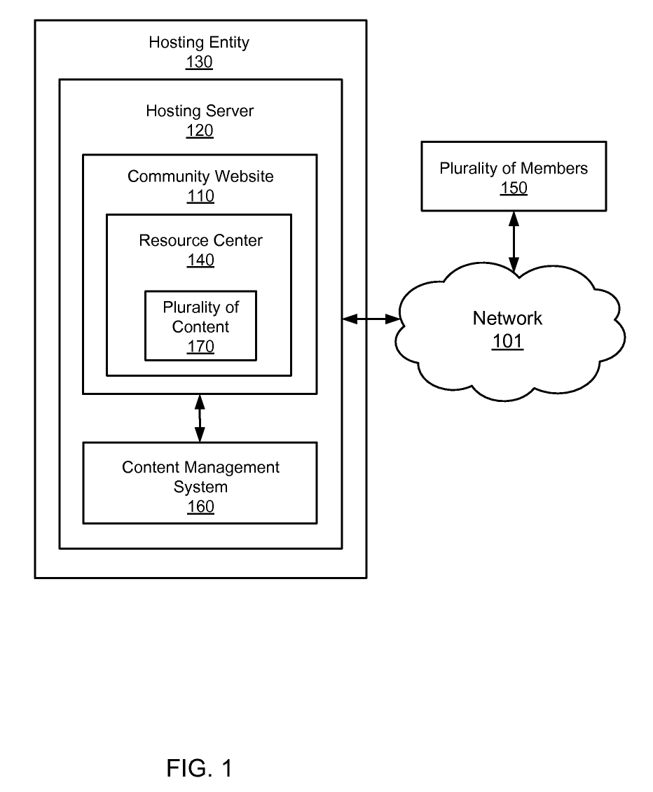

A streamlined example embodiment of a system for providing and managing an online business community is illustrated in FIG. 1. The illustrated embodiment includes a Community Website 110 hosted on at least one Hosting Server 120, said at least one Hosting Server 120 maintained by a Hosting Entity 130 and communicatively coupled to a Network 101; a Resource Center 140 accessible to a plurality of Members 150 via said Community Website 110, said Resource Center 140 having a plurality of Content 170 wherein at least some of said plurality of Content 170 is generated by at least one of said plurality of Members 150; and a Content Management System 160 having the ability to manage content on said Community Website 110.

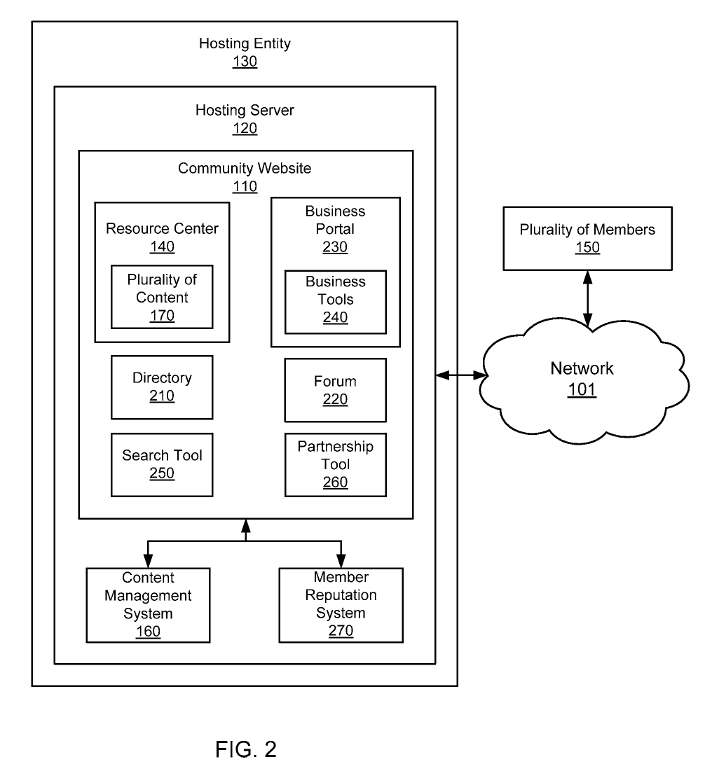

A more detailed example embodiment of a system for providing and managing an online business community is illustrated in FIG. 2. The illustrated embodiment includes a Community Website 110 hosted on at least one Hosting Server 120, said at least one Hosting Server 120 maintained by a Hosting Entity 130 and communicatively coupled to a Network 101; a Resource Center 140 accessible to a plurality of Members 150 via said Community Website 110, said Resource Center 140 having a plurality of Content 170 wherein at least some of said plurality of Content 170 is generated by at least one of said plurality of Members 150; and a Content Management System 160 having the ability to manage content on said Community Website 110. In this example embodiment, the Community Website 110 may be password-protected and may further comprise a Directory 210, a Forum 220, a Business Portal 230 allowing said plurality of Members to manage Business Tools 240, and a Partnership Tool 260 allowing Members 150 to for partnerships with other Members 150.

The plurality of Members 150 may comprise any Network 101 user wishing to access the Community Website 110. As non-limiting examples, Members 150 may be individuals, entities, businesses, corporations, organizations, automated systems, or computers. Members 150 may be required to register on the Community Website 110 before gaining access, possibly by providing contact information and generating a username and password. In alternate embodiments, Members 150 may be subdivided into categories, perhaps “premium” and “standard” members. Premium members may be provided more access to Community Website 110 content than standard members, possibly by being provided with password access to password-protected areas of the Community Website 110. Alternatively, standard members may be provided access to all areas of the Community Website 110, but permitted only limited interactivity (e.g., may read, but not post content).

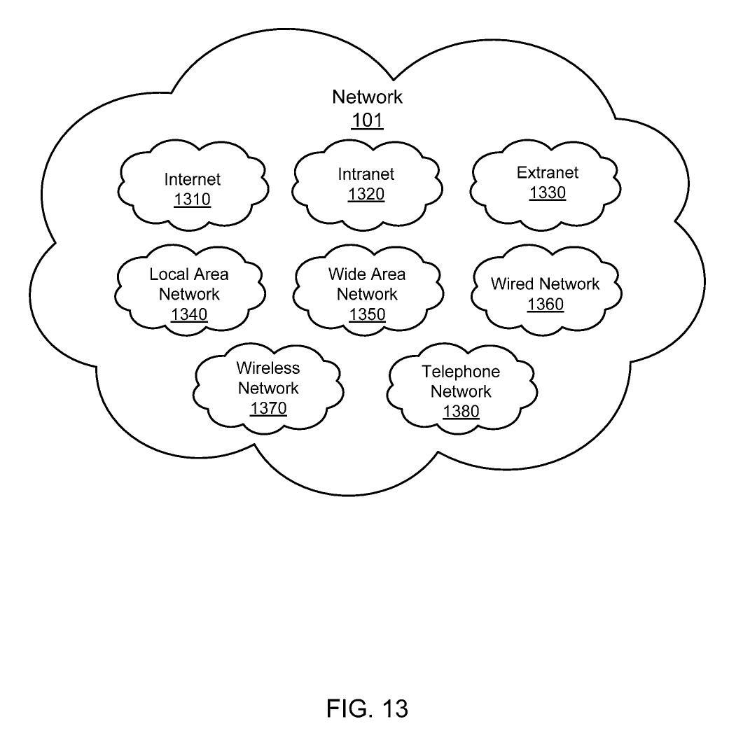

The example embodiments herein place no limitation on Network 101 configuration or connectivity. Thus, as non-limiting examples—and as illustrated in FIG. 13—the network 101 could comprise the Internet 1310, an intranet 1320, an extranet 1330, a local area network 1340, a wide area network 1350, a wired network 1360, a wireless network 1370, a telephone network 1380, or any combination thereof. The at least one Hosting Server 120 could be any computer or program that provides services to other computers, programs, or users either in the same computer or over a computer network. As non-limiting examples, the at least one Hosting Server 120 could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof).

The at least one Hosting Server 120 may be communicatively coupled to the Network 101 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

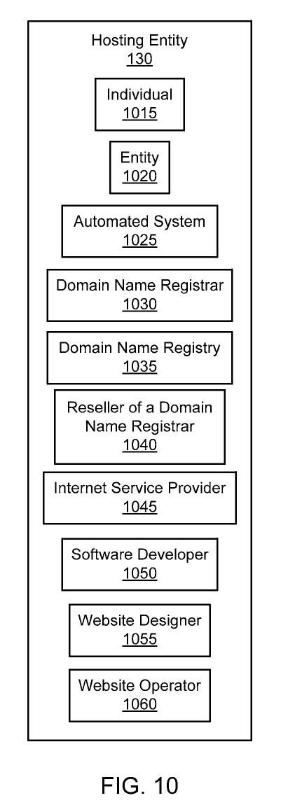

A Hosting Entity 130 may provide and/or maintain the at least one Hosting Server 120 and may comprise any individual, entity, or organization. Thus, as non-limiting examples—and as illustrated in FIG. 10—the Hosting Entity 130 may comprise an individual 1015, an entity 1020, an automated system 1025, a domain name registrar 1030, a domain name registry 1035, a reseller of a domain name registrar 1040, an Internet service provider 1045, a software developer 1050, a website designer 1055, a website operator 1060, or any combination thereof.

The Community Website 110 may be hosted on the at least one Hosting Server 120 by, as a non-limiting example, subscribing to a hosting provider (e.g., GODADDY.COM) for website hosting services (e.g., GODADDY.COM's HOSTING PLANS). Alternatively, the Community Website 110 may be hosted on any computer or program that provides services to other computers, programs, or users either in the same computer or over a computer network including, but not limited to, application, communication, mail, database, proxy, fax, file, media, web, peer-to-peer, or standalone servers. The Community Website 110 may provide Members 150 access to a Resource Center 140, Directory 210, Forum 220, and/or Business Portal 230. The Community Website 110 may be password protected, either on a Homepage 510 and/or any other webpage. Alternatively, Single Sign-On (SSO) functionality may be enabled allowing properly-authenticated Members 150 complete website content access, without requiring additional passwords or login.

The Community Website 110, either on a homepage and/or any other webpage, may incorporate a Search Tool 250 to assist Members 150 in their efforts to locate particular content. The Search Tool 250 may comprise a search box in which Members 150 enter the keywords to be searched. It may utilize any data search mechanism known in the art or developed in the future including, but not limited to, desktop, network, or online search engines and may utilize, among others, uninformed, list, tree, graph, SQL, tradeoff based, informed, adversarial, constraint satisfaction, string, genetic, sorting, probabilistic, tabu, federated, minimax, and/or ternary search algorithms. Searches of all Community Website 110 content may be enabled, perhaps by placing the search box on the Homepage 510, or perhaps on the Internet browser's toolbar. By placing the search box on specific webpages, searches limited to the specific content associated with that webpage may be enabled. Alternatively, Members 150 may be provided with a menu from which they may select the of Community Website 110 content to be searched.

The Resource Center 140 may be accessible to the plurality of Members 150 via the Community Website 110, possibly as a link on a webpage. The link may open a Resource Center Webpage 530 that may provide Members 150 with access to Resource Center 140 content. Alternatively, the link may redirect Members 150 to another website, webpage, or resource providing access to Resource Center 140 content. The Resource Center 140 may provide Members 150 access to a plurality of Content 170, some of which may have been generated by at least one of said plurality of Members 150.

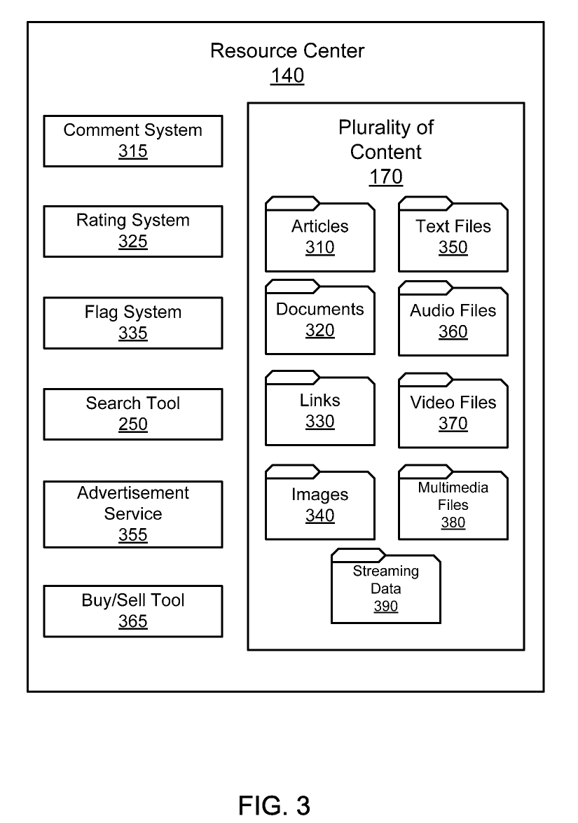

As shown in FIG. 3, the plurality of Content 170 may comprise a plurality of articles 310, a plurality of documents 320, a plurality of links 330, a plurality of images 340, a plurality of text files 350, a plurality of audio files 360, a plurality of video files 370, a plurality of multimedia files 380, streaming data 390, or any combination thereof. The plurality of Content 170 may include any piece of information that Members 150 may think is useful to other Members 150 including, but not limited to, articles (authored by Members 150 or others), documents in any format (e.g., .doc, .pdf, .tif, etc.), blogs, video clips, audio clips, podcasts, photographs, spreadsheets, flash content, links to other websites, and/or any other resource.

The plurality of Content 170 may be generated by Members 150, perhaps locally on their computers, and posted to the Resource Center 140 for comment, review, flagging, searching, downloading, and/or any other use Members 150 may have for the Content 170. Members 150 may contribute to the plurality of Content 170 in many ways, perhaps by clicking on a “contribute button” that may be available on a Resource Center Webpage 530. The button may open a pop-up window (or another webpage) with a form that may allow Members 150 to free-flow type an article, paste a URL link, or choose to upload other material. For example, Members 150 may draft an article on their personal computer, possibly using a word processing program such as MICROSOFT WORD and save the file to their local hard drive. The Members 150 may then login to the Community Website 110, access the Resource Center 140, and upload their article where it may be accessed by other Members 150. This general process may be repeated for any of the data types discussed in the previous paragraph. Alternatively, Members 150 may simply upload links to other Internet resources that may be of use to other Members 150. Uploaded Content 170 may be pre-screened for malicious programs and may be put through a “bad word” filter for possible review by the Hosting Entity 130 prior to posting. Each Member 150 may be required to sign an agreement accepting prescribed style and appropriateness guidelines.

Members 150 may upload the plurality of Content 170 to the Resource Center 140 utilizing any method of transferring data known in the art or developed in the future. Such methods can generally be classified in two categories: (1) “pull-based” data transfers where the receiver initiates a data transmission request; and (2) “push-based” data transfers where the sender initiates a data transmission request. Both types are expressly included in the embodiments illustrated herein, which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known in the art or developed in the future may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

The Resource Center 140 also may include a tool allowing Members 150 to categorize uploaded Content 170, possibly comprising a pop-up window (or redirection to another webpage) that appears on the Community Website 110 when Members 150 upload Content 170. The tool may ask Members 150 to provide categorical information about the Content 170, such as title, related keyword, topic, and/or type of Content 170 (e.g., article, audio file, or photograph). This categorical information may then be associated with the uploaded Content 170, which may allow the plurality of Content 170 to be organized in the Resource Center 140 in a wide variety of ways that simplifies access by Members 150. In an example embodiment, the Resource Center 140 may be accessible to Members 150 via the Resource Center Webpage 530. The plurality of Content 170 may be organized on the Resource Center Webpage 530 by, as non-limiting examples, titles, topics, keywords, popular searches, recent searches, type of Content 170 (e.g., article, audio, video), and/or featured resources (perhaps those selected and highlighted by the Hosting Entity 130).

As shown in FIG. 3, the Resource Center 140 also may comprise a Comment System 315, a Rating System 325, a Flag System 335, a Search Tool 250, an Advertisement Service 355, a Buy/Sell tool 365, or any combination thereof. The Comment System 315 and Rating System 325 allow Members 150 to leave comments and/or ratings, accessible to other Members 150, regarding any of the plurality of Content 170 in the Resource Center 140 (or any of the Community Website's 110 content). The Comment System 315 and/or Rating System 325 may comprise a pop-up window (or redirection to another webpage) that appears on the Community Website 110 when Members 150 click a “leave comment, “rate this resource,” or similar button. Members 150 may then enter a rating, comment, and/or title for their rating or comment, both of which may then be associated with the subject Content 170 for other Members 150 to view. The Rating System 325 may use any scale that communicates the Members' 150 rating of the resource, such as a 1-10 scale, number of stars, grades (e.g., A, B, C, D, or F), etc. Open-source comment system software may be used to implement the Comment System 315, such as YACCS, HALOSCAN, MYCHINCO, MOBATALK, PARLATORIO, INSTACOMMENT, or MPCS (Multi-Page Comment System). Alternatively, proprietary software may be used.

The Flag System 335 may allow Members 150 to flag Content 170 as potentially inappropriate. This feature may allow Members 150 to self-police the plurality of Content 170 within the Resource Center 140. By flagging a specific piece of content, Members 150 may ensure that it is reviewed by the Hosting Entity 130 (or any another moderator) for propriety. Alternatively, the Hosting Entity 130 (or any another moderator), perhaps an automated content review system, may flag Content 170 as potentially inappropriate. Members 150 may vote, perhaps via the Comment System 315 or a Forum 220, to determine whether to delete the flagged content from the Resource Center 140. The Flag System 335 may comprise a pop-up window (or redirection to another webpage) that appears on the Community Website 110 when Members 150 click a “flag this resource” or similar button. Members 150 may then enter a flag, perhaps including a comment, both of which may then be associated with the subject Content 170 for other Members 150 to view. Alternatively, the Hosting Entity 130 (or any another moderator), perhaps an automated content review system, may simply elect to delete Content 170 that they determine to be inappropriate.

The Resource Center 140 also may have a Search Tool 250 enabling Members 150 to search the Resource Center 140 and plurality of Content 170 for specific subject matter.

The Advertisement Service 355 may comprise any system or method allowing Members 150 or any third-part advertiser to post advertisements for goods or services for review by Members 150. As a non-limiting example, the Advertising Service 355 may comprise an advertisement directory accessible to Members 150 via a webpage on the Community Website 110. In this example embodiment, Members 150 or any third-part advertiser may generate, post, or upload advertisements to the Advertisement Service 355, where other Members 150 may search (perhaps by subject, category, or vendor) and review the advertisements. Alternatively, the Advertisement Service 355 may utilize a contextual advertisement model, wherein Members 150 or any third-part advertiser wishing to advertise may subscribe to the Advertising Service 355, which may maintain a database of advertisers and advertisements. The advertisers (possibly other Members 150) may pay the Advertising Service 355 for inclusion in the database. When Members 150 access the Community Website 110, the Advertising Service 355 may generate an advertisement that relates in some way to the content on the displayed webpage. The advertisements may be targeted to the predicted interests of Members 150 viewing the webpage. To accomplish this, advertisement generation software may parse the webpage content into keywords and select advertisements from its database based upon those keywords. For example, if Members 150 view an article in the Resource Center 140 about “green celery,” the generated advertisements may include those related to the subjects “green” and/or “celery.” The advertisements may comprise any type of online advertising including, but not limited to, text, graphics, video, and/or audio data. The advertisement also could comprise a hyperlink to another website, another website, and/or both. Among other types, the advertisement could be a pop-up, pop-under, banner, contextual, targeted, and/or focused ad that relates in some manner to the webpage content. Any and all additional methods of online advertising known in the art or developed in the future are included in the scope of the Advertising Service 355.

The Resource Center 140 also may comprise a Buy/Sell Tool 365 allowing Members 150 to sell and/or purchase products, goods, and/or services. The Buy/Sell Tool 365 may comprise any method of online purchasing known in the art or developed in the future. As a non-limiting example, shopping cart software (i.e., software used in e-commerce to assist online purchases), such as GODADDY.COM's QUICK SHOPPING CART, may be implemented to enable the Buy/Sell Tool 365. Such software may be installed on the Hosting Server 120, or on another secure server that may accept sensitive ordering information. Shopping carts may be implemented using HTTP cookies or query strings. Shopping cart software typically consists of two components, a storefront and an administration tool. The storefront may be the webpage on the Community Website 110 accessed by Members 150 to make a purchase. It may contain the products, goods, and/or services for sale along with pricing and terms of sale. The storefront may integrate with the Advertising Service 355, thereby allowing Members 150 to purchase products, goods, and/or services directly from advertisements. The administration tool may allow selling Members 150 to add and edit products, categories, discounts, shipping, and/or payment terms. Selling Members 150 may delegate administrative control to the Hosting Entity 130 or other Members 150. Purchasing Members 150 may pay for purchases in a wide variety of ways, including, but not limited to credit card, debit card, electronic money, check, wire transfer, COD, and/or PAYPAL.

A Directory 210 may be accessible to the plurality of Members 150 via the Community Website 110, possibly as a link that may open a Directory Webpage 520 that may provide Members 150 with access to Directory 210 content. Alternatively, the link may redirect Members 150 to another website, webpage, or resource providing access to Directory 210 content. The Directory 210 is a feature allowing Members 150 to generate, post, upload, and/or search a plurality of Business Profiles 410 and a plurality of Individual Profiles 420. It may provide an online location for Members 150 to locate and review information about each other. Some of both profile types may be generated by the Members 150 themselves. Alternatively, a third party—perhaps the Hosting Entity 130 or other Members 150—may generate and post profiles. In an example embodiment, Members 150 may generate, post, or upload Business Profiles 410 and/or Individual Profiles 420 to the Directory 210, where other Members 150 may search (perhaps by subject, category, product, or service) and review the profiles.

Members 150 who may wish to promote businesses may generate Business Profiles 410 that may contain basic information about the business. Via a Search Tool 250 (that may be located anywhere on the Community Website 110 or Directory Webpage 520), other Members 150 may search for profiles meeting their search criteria. Examples of information that may be stored in Business Profiles 410 include name, address and locality information, contact information, business categories, product categories, key employees, company description, listing and/or links to the business' partners, reviews, ratings, map and/or directions, and links to the company's website, storefront, blog, and/or forum. Business Profile 410 information may be added to the Directory 210 using any method known in the art or developed in the future. As a non-limiting example, upon request, the Community Website 110 may present Members 150 with a form having populatable fields for relevant business information. The Business Profiles 410 may then be stored in a database for subsequent searching. Alternatively, Business Profiles 410 may be generated by Members 150, perhaps locally on their computers, uploaded, and posted to the Directory 210 for comment, review, flagging, searching, downloading, and/or any other use Members 150 may have for the Business Profiles 410.

Where Business Profiles 410 provide Members 150 with information about businesses, the Individual Profiles 420 provide Members 150 with information about each other. As non-limiting examples, the Individual Profiles 420 may provide other Members 150 with the listed individual's name, address, phone number, website, digital identity, business name, and/or any other information the listed individual is willing to share with other Members 150. Individual Profile 420 information may be added to the Directory 210 using any method known in the art or developed in the future. As a non-limiting example, upon request, the Community Website 110 may present Members 150 with a form having populatable fields for relevant individual information. The Individual Profiles 420 may then be stored in a database for subsequent searching. Alternatively, Individual Profiles 420 may be generated by Members 150, perhaps locally on their computers, uploaded, and posted to the Directory 210 for comment, review, flagging, searching, downloading, and/or any other use Members 150 may have for the Individual Profiles 420.

The Directory 210 may further comprise, as described in detail above, a Comment System 315, a Rating System 325, a Flag System 335, a Search Tool 250, an Advertisement Service 355, or any combination thereof. These systems allow Members 150 to comment, rate, flag, search, and/or advertise on Directory 210 in the same manner discussed above with respect to the Resource Center 140.

The Community Website 110 also may comprise a Forum 220 capable of being written to and read by said plurality of Members 150. The Forum 220 is a feature allowing Members 150 to communicate and interact with each other via any online communication method known in the art or developed in the future including, but not limited to, Internet forums (e.g., Web forums, message boards, discussion boards, (electronic) discussion groups, discussion forums, bulletin boards), IM (instant messaging), VoIP (voice over IP), email, blogs, and/or any combination thereof.

As a non-limiting example, an Internet forum Web application may be used. Open-source forum software packages are widely available on the Internet and are written in a variety of programming languages, such as PHP, Perl, Java, and ASP. The configuration and records of posts can be stored in text files or in a database. Each package offers different features, from the most basic, providing text-only postings, to more advanced packages, offering multimedia support and formatting code. Many packages can be integrated easily into an existing website to allow visitors to post comments on articles.

Several other Web applications, such as weblog (blog) software (e.g., GODADDY.COM's QUICK BLOGCAST, WORDPRESS, and/or SLASHCODE), also may incorporate forum features. With WORDPRESS, for example, user comments at the bottom of a blogger's post allow for a single-threaded discussion of any given blog post. SLASHCODE, on the other hand, is far more complicated, allowing fully-threaded discussions and incorporating a robust moderation and meta-moderation system as well as many of the profile features available to forum users. Full content management systems such as DRUPAL or MAMBO can also incorporate full-blown forums as plugins or basic features of forums in other portions of their website. IM (instant messaging), VoIP (voice over IP), or Wiki functionality also may be built into the Forum 220 to allow Members 150 to communicate via these formats.

The Hosting Entity 130, or perhaps one of the Members 150, may function as an administrator that has the ability to edit, delete, move, or otherwise modify any thread on the Forum 220. The administrator also may have the ability to close or modify a particular discussion, change major software items, and ban, delete, or create members. A moderator (that also may be the Hosting Entity 130, or perhaps one of the Members 150) may have a subset of these powers, which may include editing, deleting, and moving threads, mass pruning, warning Members 150 of offences, and changing minor Forum 220 details.

The Community Website 110 also may provide a Business Portal 230 allowing Members 150 to manage their businesses' Business Tools 240. The Business Portal 230 may be accessible to Members 150 via the Community Website 110, perhaps on a Business Portal Webpage 550. The Business Portal 230 may function as a control panel allowing Members 150 to manage their Business Tools 240. As a non-limiting example, it may comprise an access-protected link to a company's “private” profile webpage for the use of authorized Members 150. The Business Portal 230 may be password protected, either on a Portal Webpage 550 and/or any other webpage on the Community Website 110. Alternatively, the Community Website 110 may employ Single Sign-On (SSO) functionality, which may allow properly-authenticated Members 150 complete website content access—including access to the Business Portal 230—without requiring additional passwords or login. The Business Portal Webpage 550 may comprise controls and/or buttons that control the settings of a business' private Business Tools 240. The Business Tools 240 that may be managed via the Business Portal 230 may include any Web presence and/or e-commerce tool including, but not limited to, website management (e.g., appearance and/or functionality), communication systems (e.g., e-mail, instant messaging (IM), and/or voice over IP (VoIP)), blogs, forums, domain names, inventory systems, shared files, calendaring systems, and/or SSL certificates. The Business Portal 230 provides Members 150 with a secure, focal location on the Community Website 110 where all aspects of their businesses' online presence may be managed.

The Community Website 110 also may provide a Partnership Tool 260 allowing Members 150 to form partnerships with other Members 150. The Partnership Tool 260 may be accessible to Members 150 via the Community Website 110, perhaps on a Partnership Webpage. Alternatively, links to the Partnership Tool 260 may be made available on any other webpage on the Community Website 110. Such links may present themselves as tabs, buttons, or hyperlinks possibly entitled “My Partners,” “Partnerships,” and/or some other similar designation. Members 150 may establish partnerships with other Members 150, perhaps those that are customers or suppliers, provide a recommended product or service, or have any other business (or other) relationship upon which the Members 150 wish to establish a partnership. Members 150 who form partnerships may invite other Members 150 to join, possibly by communicating via a Forum 220, clicking on a link on a Member's 150 Business Profile 410 or Individual Profile 420, or any other method of communication enabled by the Community Website 110 detailed above. A list of each Member's 150 partners may appear on the Partnership Webpage, perhaps along with links to the partner's Business Profile 410 or Individual Profile 420.

Partnerships may be private—that is accessible only to those Members 150 who have formed the partnership. Such private partnerships may require Members 150 to take some affirmative action to join, perhaps by providing some private information and obtaining a username and password (or any other form of electronic identification that will identify Members 150 who have formed partnerships to each other and provide access to the Partnership Webpage). Alternatively, partnerships may be public, perhaps being open and accessible to any Member 150. Partners may utilize an Advertisement Service 355 and/or Buy/Sell Tool 365 to advertise, sell, and purchase goods and services to and from each other. Alternatively, all Members 150 may access advertisements and purchase goods and/or services. Such tools may be accessible on a Partnership Webpage and/or any other Community Website 110 webpage. Partners also may communicate and collaborate with each other via the tools discussed in detail above including, but not limited to, the Resource Center 140, Directory 210, and Forum 220. Additionally, the Partnership Tool may employ calendaring, e-mail, VoIP, IM, and/or Wiki functionality accessible to partners. Partners also may be provided with tools (perhaps utilizing Forum 220 functionality) to send out broadcast messages to their partners. These messages may appear on public and private webpages, depending on the type of message.

The embodiment illustrated in FIG. 2. also comprises a Content Management System 160 having the ability to manage content on the Community Website 110. The Content Management System 160 may comprise a software system used to manage and control the dynamic collection of content on the Community Website 110 and may facilitate document control, auditing, and/or editing. Software running the Content Management System 160 may preferably reside on said at least one Hosting Server 120, but also may reside on one or more different servers. The Content Management System 160 may comprise multiple levels of content review systems including, but not limited to, a Flag System 335 that may allow Members 150 to self-police the Community Website 110 by flagging content as potentially inappropriate. By flagging a specific piece of content, Members 150 may ensure that it is reviewed by the Hosting Entity 130 for propriety. If the Hosting Entity 130 determines that the flagged content is inappropriate, the subject content may be deleted, edited, and/or otherwise labeled as inappropriate, perhaps by a change in color of the content, or with an express label.

Alternatively, Members 150 may vote, perhaps via the Comment System 315 or Forum 220, to determine whether to delete, edit, and/or otherwise label the flagged content. The Flag System 335 also may automatically delete, edit, and/or label content receiving a pre-set number of flags from Members 150. The Flag System 335 may comprise a pop-up window (or redirection to another webpage) that appears on the Community Website 110 when Members 150 click a “flag this content” or similar button. Members 150 may then enter a flag, perhaps including a comment, both of which may then be posted with the subject content for other Members 150 to view. The Content Management System 160 also may provide the Hosting Entity 130 with a manual override allowing the Hosting Entity 130 to edit, delete, and/or otherwise label any Community Website 110 content as needed. There are numerous open-source (e.g., ALFRESCO, CMSIMPLE, or DRUPAL) and commercial (e.g., CORE MEDIA CMS, MICROSOFT SHAREPOINT, or INGENIUX CMS) content management systems that may be used to support this functionality. Alternatively, a proprietary system may be implemented.

The embodiment illustrated in FIG. 2. also comprises a Member Reputation System 270 having the ability to establish and publish a Member Trust Level. Membership Trust levels are an indication of how well Members 150 are trusted by other Members 150. The Member Reputation System 270 may use any scale that communicates a Member's Trust Level, such as a 1-10 scale, number of stars, grades (e.g., A, B, C, D, or F), etc. Member Trust Levels may go up or down based on input from Members 150, perhaps via feedback systems. For example, the Member Reputation System 270 may comprise a Comment System 315 and/or a Rating System 325. The Comment System 315 and Rating System 325 allow Members 150 to leave comments and/or ratings, accessible to other Members 150, regarding the Member Trust Level of other Members 150. The Comment System 315 and/or Rating System 325 may comprise a pop-up window (or redirection to another webpage) that appears on the Community Website 110 when Members 150 click a “leave comment, “rate this Member,” or similar button. Members 150 may then enter a Member Trust Level, rating, comment, and/or title for their rating or comment, both of which may then be associated with the subject Member 150 for other Members 150 to view. Members 150 may similarly rate and/or establish trust levels for business listed in the Business Profiles 410 and/or individuals listed in the Individual Profiles 420. Businesses and/or individuals' reputation may be rated generally, and/or in specific categories, such as customer service, product quality, price, etc.

The Member Reputation System 270 may establish a Member's 150 initial Member Trust Level that may subsequently vary based on Members 150 feedback and ratings. The initial Member Trust Level may be established through a reputation verification process that verifies some aspect of a Member's 150 background and/or contact information. For example, a Member's 150 domain name may be verified via GODADDY.COM's CERTIFIED DOMAIN NAME service. Alternatively, any method of verifying a Member's 150 identity, background information, domain name, e-mail, URL, and/or or digital identity ownership or control, and/or contact information may be used.

A Member's 150 access to the Community Website 110 and/or any of its functionality may be altered based upon the Member's 150 Member Trust Level. As a non-limiting example, a Member 150 with a lower Member Trust Level may be denied access to the Resource Center 140, Directory 210, or Forum 220. Such a Member 150 may be denied permission to post comments, purchase goods or services, or upload resources, but perhaps may still be permitted to review content posted by other Members 150. A sufficiently low Member Trust Level may result in complete denial of Community Website 110 access. On the other hand, a Member 150 with a higher Member Trust Level may be provided with a higher level of Community Website 110 access and/or permissions. For example, such a Member 150 may be authorized to act as a moderator and/or content editor.

The Member Reputation System 270 may comprise any a software system enabling the above-described functionality. Software running the Member Reputation System 270 may preferably reside on said at least one Hosting Server 120, but also may reside on one or more different servers.

A System for Providing and Managing an Online Business Community

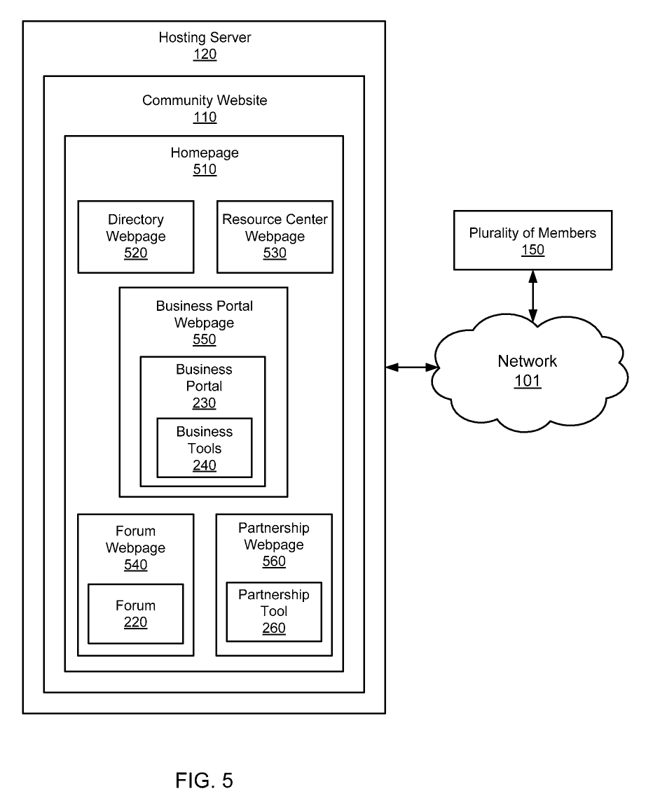

Another example embodiment of a system for providing and managing an online business community is illustrated in FIG. 5. The illustrated embodiment includes a Community Website 110 hosted on at least one Hosting Server 120, said at least one Hosting Server 120 communicatively coupled to a Network 101; a Homepage 510 accessible via said Community Website 110, said Community Website 110 accessible to a plurality of Members 150 via said Network 101; a Resource Center Webpage 530 accessible via said Homepage 510, said Homepage 510 accessible to said plurality of Members 150 via said Network 101; a Directory Webpage 520 accessible via said Homepage 510, said Homepage 510 accessible to said plurality of Members 150 via said Network 101; a Forum Webpage 540 accessible via said Homepage 510, said Homepage 510 accessible to said plurality of Members 150 via said Network 101; a Business Portal Webpage 550 accessible via said Homepage 510, said Homepage 510 accessible to said plurality of Members 150 via said Network 101; and a Partnership Webpage 560 accessible via said Homepage 510, said Homepage 510 accessible to said plurality of Members 150 via said Network 101.

The Homepage 510 may be password-protected. Alternatively, Single Sign-On (SSO) functionality may be enabled allowing properly-authenticated Members 150 complete website content access, without requiring additional passwords or login. The Homepage 510 may display recent news (possibly via RSS feeds) and/or featured Content 170, possibly organized by topic and/or keyword. The Homepage 510 also may be customizable (in terms of both layout and displayed content) according to Members' 150 preferences. For example, an authenticated member's Homepage 510 may display that member's (and/or other Members' 150) favorite, recently-accessed, and/or recently-searched-for Content 170, Business Profiles 410, Individual Profiles 420, Members 150, Business Tools 240, Forums 220, links, and/or other content. Authenticated Members' 150 Homepages 510 also may display profile information (e.g., username, location, etc.) that may be edited via the Homepage 510. The Homepage 510 also may display links to a Resource Center Webpage 530, a Directory Webpage 520, a Forum Webpage 540, and a Business Portal Webpage 550.

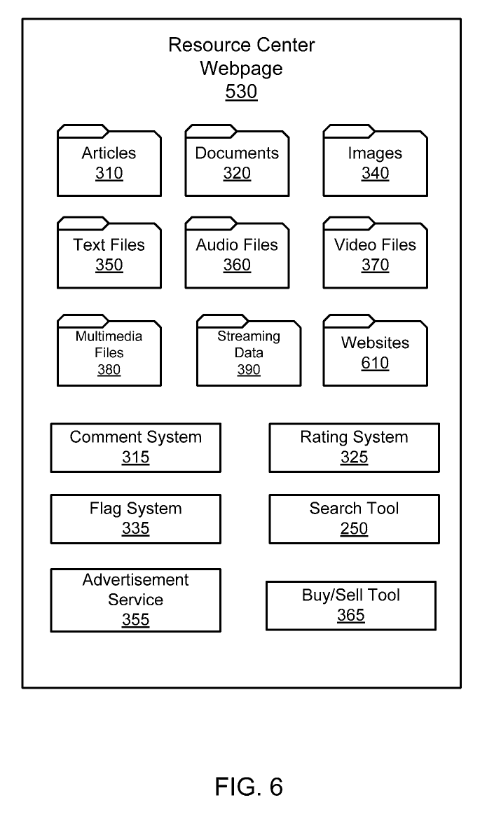

As illustrated in FIG. 6, the Resource Center Webpage 530 may comprise links to a plurality of articles 310, a plurality of documents 320, a plurality of websites 610, a plurality of images 340, a plurality of text files 350, a plurality of audio files 360, a plurality of video files 370, a plurality of multimedia files 380, streaming data 390, a Comment System 315, a Rating System 325, a Flag System 335, a Search Tool 250, an Advertisement Service 355, a Buy/Sell tool 365, or any combination thereof.

In an example embodiment, any individual or entity with access to the Resource Center Webpage 530 may post any piece of information including, but not limited to, articles (authored by Members 150 or others), documents in any format (e.g., .doc, .pdf, .tif, etc.), blogs, video clips, audio clips, podcasts, photographs, spreadsheets, flash content, and/or links to other websites or any other resource. Alternatively, such content may be generated only by Members 150, perhaps locally on their computers, and posted on the Resource Center Webpage 530 for comment, review, flagging, searching, downloading, and/or any other use Members 150 may have for it. In such an embodiment, Members 150 may contribute content in many ways. Members 150 may click on a “contribute button” that may be available on the Resource Center Webpage 530. The button may open a pop-up window (or another webpage) that includes a form that may allow Members 150 to free-flow type an article, paste a URL link, or choose to upload other content. In an example embodiment, Members 150 may draft an article on their personal computer, possibly using a word processing program such as MICROSOFT WORD and save the file to their local hard drive. The Members 150 may then login to the Community Website 110, access the Resource Center Webpage 530, and upload their article where it may be accessed by other Members 150. This general process may be repeated for any of the data types discussed above. Alternatively, Members 150 may simply upload links to other Internet resources that may be of use to other Members 150. Each Member 150 may be required to sign an agreement accepting prescribed style and appropriateness guidelines.

Members 150 may upload content to the Resource Center Webpage 530 utilizing any method of transferring data known in the art or developed in the future, including those methods described in reference to the Resource Center 140 above. The Resource Center Webpage 530 also may include a tool allowing Members 150 to categorize uploaded content, such as described in reference to the Resource Center 140 above.

The Directory Webpage 520 may be accessible to the plurality of Members 150 via the Community Website 110, possibly as a link on the Homepage 510. The Directory Webpage 520 may provide Members 150 with direct access to content, or a link may redirect Members 150 to another website, webpage, or resource providing access to content. The Directory Webpage 520 allows Members 150 to generate, post, upload, and/or search a plurality of Business Profiles 410 and a plurality of Individual Profiles 420. It will provide an online location for Members 150 to locate and review information about each other. Some of both profile types may be generated by the Members 150 themselves. Alternatively, a third party may generate and post the profiles. In an example embodiment, Members 150 may generate, post, or upload Business Profiles 410 and/or Individual Profiles 420 to the Directory Webpage 520, where other Members 150 may search (perhaps by subject, category, product, or service) and review the profiles.

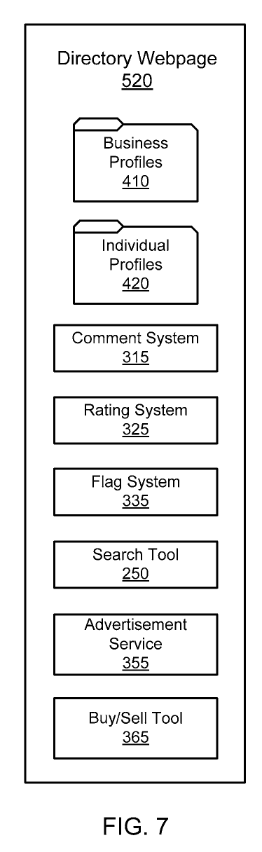

As illustrated in FIGS. 6 and 7, both the Directory Webpage 520 and the Resource Center Webpage 530 also may comprise a Comment System 315, a Rating System 325, a Flag System 335, a Search Tool 250, an Advertisement Service 355, a Buy/Sell tool 365, or any combination thereof. These systems allow Members 150 to comment, rate, flag, search, and/or advertise on these webpages.

The Community Website 110 also may comprise a Forum Webpage 540 providing Members 150 with access to a Forum 220 capable of being written to and read by said plurality of Members 150. The Forum 220 is a feature allowing Members 150 to communicate and interact with each other via any online communication method known in the art or developed in the future including, but not limited to, Internet forums (e.g., Web forums, message boards, discussion boards, (electronic) discussion groups, discussion forums, and/or bulletin boards), IM, VoIP, email, blogs, and/or any combination thereof.

The Community Website 110 also may comprise a Business Portal Webpage 550 that provides access to a Business Portal 230 allowing Members 150 to manage their businesses' Business Tools 240. The Business Portal 230 may be accessible to Members 150 via the Community Website 110, perhaps on the Business Portal Webpage 550. The Business Portal 230 may function as a control panel allowing Members 150 to manage their Business Tools 240.

The Community Website 110 also may comprise a Partnership Webpage 560 that provides links to a Partnership Tool 260, which allows Members 150 to establish partnerships with other Members 150. Such links may present themselves as tabs, buttons, or hyperlinks possibly entitled “My Partners,” “Partnerships,” and/or some other similar designation.

A System for Providing and Managing an Online Business Community

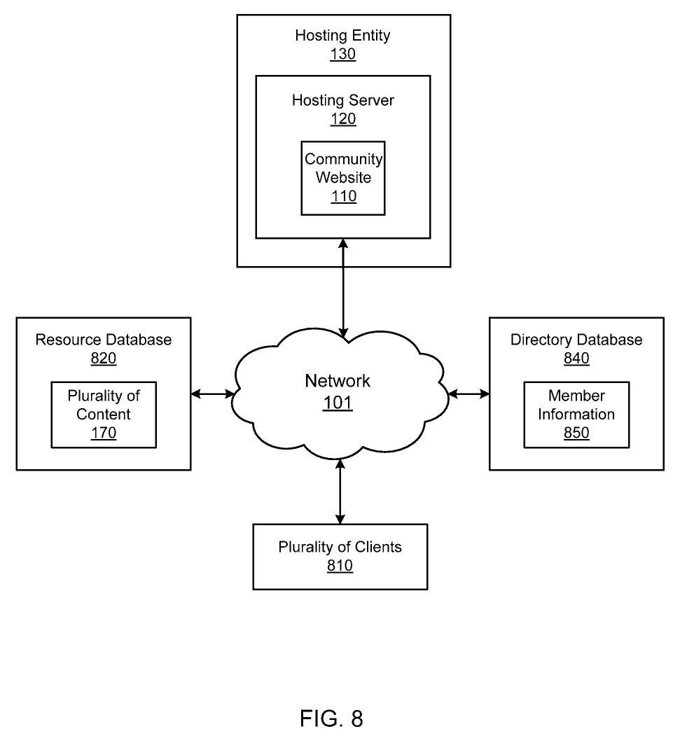

Another streamlined example embodiment of a system for providing and managing an online business community is illustrated in FIG. 8. The illustrated embodiment includes at least one Hosting Server 120 maintained by a Hosting Entity 130; a Community Website 110 accessible to a plurality of Clients 810, said Community Website 110 hosted on said at least one Hosting Server 120; a Resource Database 820 storing a plurality of Content 170, wherein at least some of said Content 170 is generated by a Member 150; a Directory Database 840 storing a plurality of Member Information 850; and a Network 101 communicatively coupling said Hosting Server 120, said Community Website 110, said plurality of Clients 810, said Resource Database 820, and said Directory Database 840.

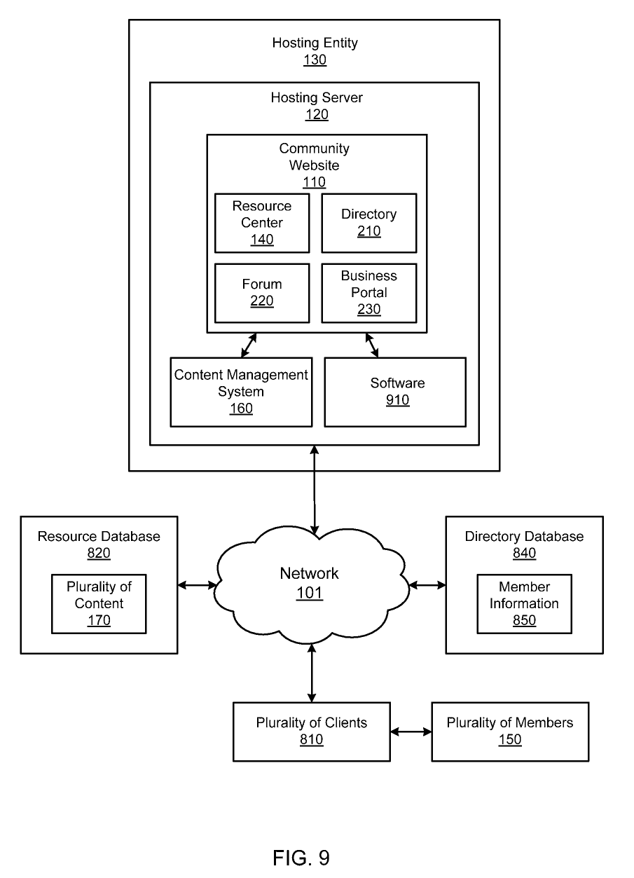

A more detailed example embodiment of a system for providing and managing an online business community is illustrated in FIG. 9. The illustrated embodiment includes at least one Hosting Server 120 maintained by a Hosting Entity 130; a Community Website 110 accessible to a plurality of Clients 810, said Community Website 110 hosted on said at least one Hosting Server 120 and having a Resource Center 140, Directory 210, Forum 220, and a Business Portal 230; a Resource Database 820 storing a plurality of Content 170, wherein at least some of said Content 170 is generated by a Member 150; a Directory Database 840 storing a plurality of Member Information 850; a Content Management System 160 having the ability to manage content on said Community Website 110; and a Network 101 communicatively coupling said Hosting Server 120, said Community Website 110, said plurality of Clients 810, said Resource Database 820, and said Directory Database 840. Machine-executable software 910 for providing a Resource Center 140, Directory 210, Forum 220, Business Portal 230, or any combination thereof may preferably reside on said at least one Hosting Server 120, but also may reside on one or more different servers.

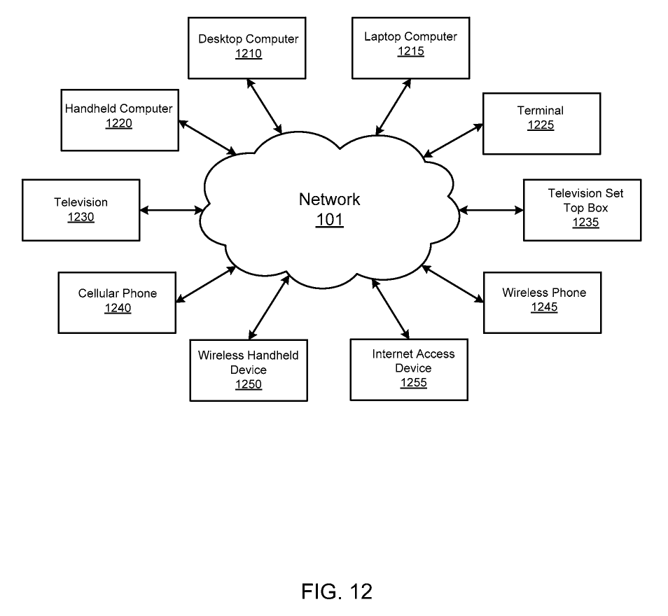

As illustrated in FIG. 12, the plurality of Clients 810 may comprise a desktop computer 1210, a laptop computer 1215, a hand held computer 1220, a terminal 1225, a television 1230, a television set top box 1235, a cellular phone 1240, a wireless phone 1245, a wireless hand held device 1250, an Internet access device 1255, a rich client, thin client, or any other client functional within a client-server computing architecture.

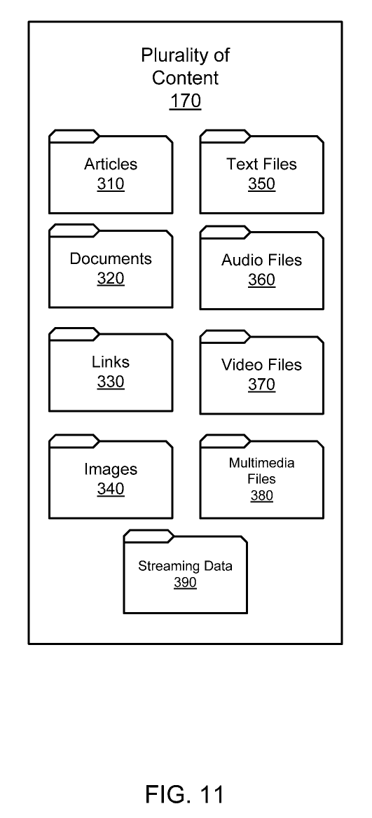

In this example embodiment—and as illustrated in FIG. 11—the plurality of Content may comprise a plurality of articles 310, a plurality of documents 320, a plurality of links 330, a plurality of images 340, a plurality of text files 350, a plurality of audio files 360, a plurality of video files 370, a plurality of multimedia files 380, streaming data 390, or any combination thereof. Content 170 may be stored in a Resource Database 820 and may be accessible via the Resource Center 140 on the Community Website 110. Structurally, the Resource Database 820 may comprise any collection of data. As non-limiting examples, the Resource Database 820 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage located on at least one Hosting Server 120, a computer, a client, another server, or any other storage device. In the embodiment illustrated in FIG. 9, the Resource Database 820 is a standalone database (e.g., located on a storage device other than the Hosting Server 120) communicatively coupled to the Hosting Server 120 via the Network 101. The plurality of Content 170 may be generated by Members 150, perhaps locally on their computers, and posted to the Resource Database 820 for comment, review, flagging, searching, downloading, and/or any other use Members 150 may have for the Content 170. Members 150 may upload the plurality of Content 170 to the Resource Database 820 utilizing any method of transferring data known in the art or developed in the future, including those discussed in detail above.

Member Information 850 may be stored in the Directory Database 840 and may be accessible to Members 150 via the Directory 210 on the Community Website 110. Member information 850 may comprise any piece of information about Members 150 including, but not limited to, Business Profiles 410 and/or Individual Profiles 420. Structurally, the Directory Database 840 may comprise any collection of data. As non-limiting examples, the Directory Database 840 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage located on at least one Hosting Server 120, a computer, a client, another server, or any other storage device. In the embodiment illustrated in FIG. 9, the Directory Database 840 is a standalone database (e.g., located on a storage device other than the Hosting Server 120) communicatively coupled to the Hosting Server 120 via the Network 101.

As described in detail above, The Community Website 110 also may comprise a Forum 220 and a Business Portal 230. The embodiment illustrated in FIG. 9. also comprises a Content Management System 160 having the ability to manage content on the Community Website 110. Additionally, the machine-executable software 910 described throughout this application necessary to implement the Resource Center 140, Directory 210, Forum 220, and/or Business Portal 230 may preferably reside on the at least one Hosting Server 120, but also may reside on one or more different servers.

A Method for Providing and Managing an Online Business Community

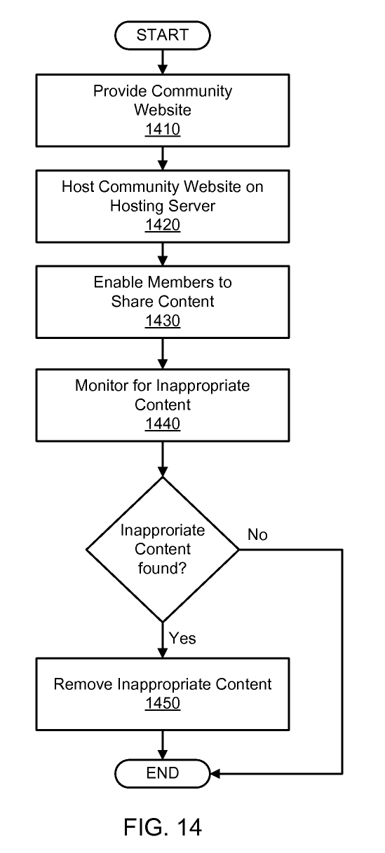

Several different methods may be used to provide and manage an online business community. In an example embodiment illustrated in FIG. 14, a Community Website 110 (accessible to a plurality of Members 150 via a Network 101) is provided (Step 1410) by hosting the Community Website 110 on at least one Hosting Server 120 (Step 1420). This embodiment places no limitation on the individual or entity providing the Community Website 110. Thus, among others, this method may be performed by an individual, entity, automated system, domain name registrar, domain name registry, reseller of a domain name registrar, Internet service provider, software developer, website designer, website operator, or any combination thereof.

The Community Website 110 may be hosted on a Hosting Server 120 by, as a non-limiting example, subscribing to a hosting provider (e.g., GODADDY.COM) for website hosting services (e.g., GODADDY.COM's HOSTING PLANS). Alternatively, the Community Website 110 may be hosted on any computer or program that provides services to other computers, programs, or users either in the same computer or over a computer network including, but not limited to, application, communication, mail, database, proxy, fax, file, media, web, peer-to-peer, or standalone servers.

A plurality of Members 150 then may be enabled to share business-related information on the Community Website 110 (Step 1430). Such information may include, but is not limited to, any piece of information that relates in any manner to business, such as a plurality of Content 170, Business Profiles, 410, Individual Profiles, 410, and/or advertisements.

The business-related information may then be monitored for inappropriate material (Step 1440), which may then be removed from the Community Website 110 (Step 1450), possibly by using a Content Management System 160 having the ability to manage content on the Community Website 110. The Content Management System 160 may comprise a software system used to manage and control the dynamic collection of content on the Community Website 110 and may facilitate document control, auditing, and/or editing. Software running the Content Management System 160 may reside on said at least one Hosting Server 120. The Content Management System 160 may comprise multiple levels of content review systems including, but not limited to, a Flag System 335 that may allow Members 150 to self-police the Community Website 110 by flagging content as potentially inappropriate. By flagging a specific piece of content, Members 150 may ensure that it is reviewed by the Hosting Entity 130 for appropriateness. If the Hosting Entity 130 determines that the flagged content is inappropriate, the subject content may be deleted, edited, and/or otherwise labeled as inappropriate, perhaps by a change in color of the content, or an express label. Alternatively, Members 150 may vote, perhaps via the Comment System 315 or Forum 220, to determine whether to delete, edit, and/or otherwise label the flagged content. The Flag System 335 also may automatically delete, edit, and/or label content receiving a pre-set number of flags from Members 150. The Flag System 335 may comprise a pop-up window (or redirection to another webpage) that appears on the Community Website 110 when Members 150 click a “flag this content” or similar button. Members 150 may then enter a flag, perhaps including a comment, both of which may then be posted with the subject content for other Members 150 to view. The Content Management System 160 also may provide the Hosting Entity 130 with a manual override allowing the Hosting Entity 130 to edit, delete, and/or otherwise label any Community Website 110 content as needed. There are numerous open-source (e.g., ALFRESCO, CMSIMPLE, or DRUPAL) and commercial (e.g., CORE MEDIA CMS, MICROSOFT SHAREPOINT, or INGENIUX CMS) content management systems that may be used to support this functionality. Alternatively, a proprietary system may be implemented. Such a Content Management System 160 may be provided by installing the above-described machine-executable software on any server communicatively coupled to a Network 101.

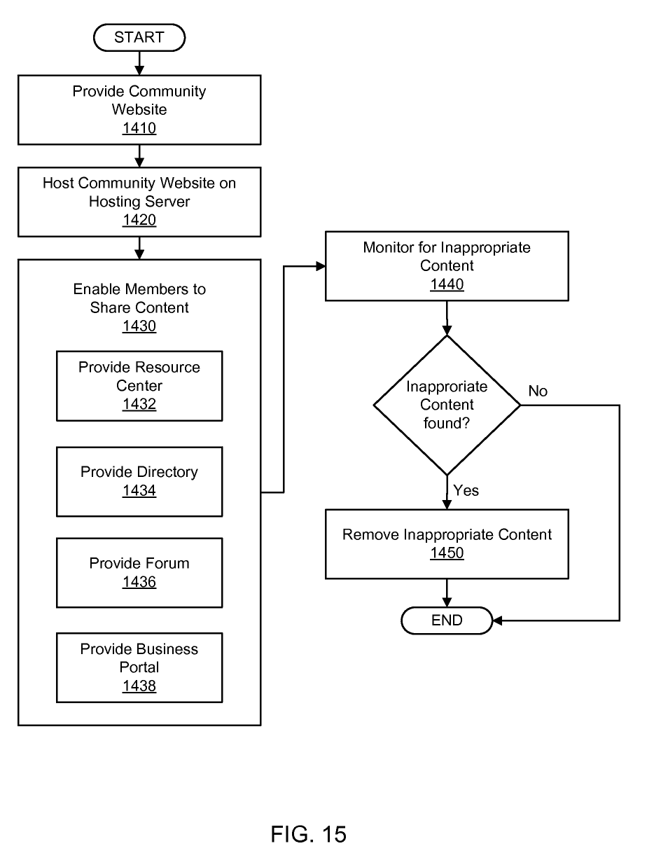

In an alternate embodiments illustrated in FIG. 15, Members 150 may be enabled to share business-related information by providing a Resource Center 140 where Members may post a plurality of Content 170; providing a Directory 210 where Members 150 may post Business Profiles 410 and/or Individual Profiles 420; providing a Forum 220 capable of being written to and read by Members 150; and/or providing a Business Portal 230 allowing Members 150 to manage Business Tools 240. These tools may be provided by installing the machine-executable software 910 described throughout this application necessary to implement the Resource Center 140, Directory 210, Forum 220, and/or Business Portal 230 on any server communicatively coupled to a Network 101.

In yet another an alternate embodiment, A Member's access to the Community Website 110 and/or any of its functionality may be altered based upon the Member's 150 Member Trust Level. A Member's 150 Member Trust Level may be monitored and, dependent upon its value, the Member's 150 access to the Community Website 110 (and/or any of its functionality) may be altered (i.e., limited or expanded). As a non-limiting example, a Member 150 with a lower Member Trust Level may be denied access to the Resource Center 140, Directory 210, or Forum 220. Such a Member 150 may be denied permission to post comments, purchase goods or services, or upload resources, but perhaps may still be permitted to review content posted by other Members 150. A sufficiently low Member Trust Level may result in complete denial of Community Website 110 access. On the other hand, a Member 150 with a higher Member Trust Level may be provided with a higher level of Community Website 110 access and/or permissions. For example, such a Member 150 may be authorized to act as a moderator and/or content editor.

A System for Providing and Managing Sub-Communities within an Online Business Community

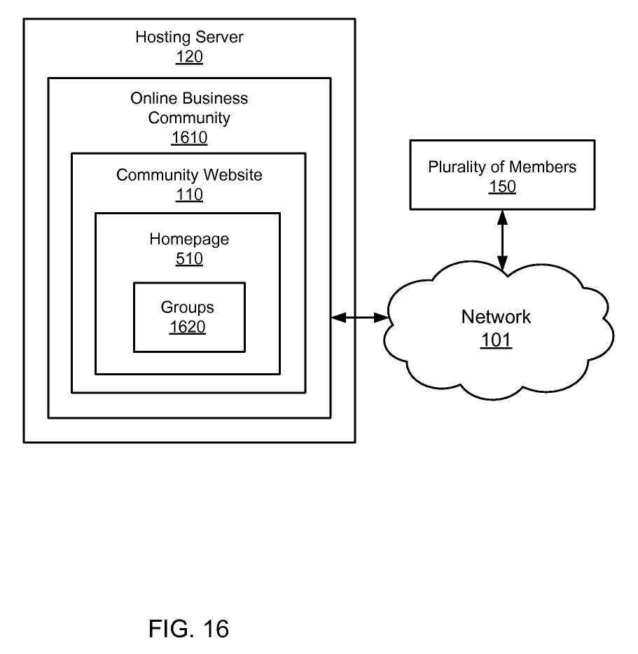

An example embodiment of a system for providing and managing sub-communities within an online business community is illustrated in FIG. 16. The illustrated embodiment includes an Online Business Community 1610 having a Community Website 110 hosted on at least one Hosting Server 120, said at least one Hosting Server 120 communicatively coupled to a Network 101; a Homepage 510 on said Community Website 110 accessible to a plurality of Members 150 via said Network; and a plurality of Groups 1620 accessible to said plurality of Members 150 via said Homepage 510, wherein each of said Groups 1620 relates to a subject.

The Online Business Community 1610 may comprise any virtual community, online community, or e-community that allows Members 150 to interact online that relates in any manner to business. The Online Business Community 1610 may comprise any of the communities described above, or such others that are known in the art or may be developed in the future. The Online Business Community 1610 may be hosted on a Hosting Server 120 and may provide a Community Website 110 (that also may be hosted on a Hosting Server 120), which is accessible to Members 150 via the Network 101.

Groups 1620 may comprise sub-communities within the Online Business Community 1610, and may comprise a collection of Members 150 with an interest in a common subject (i.e., interest, idea, task, or goal) who interact in the Groups 1620 across time, geographical, and organizational boundaries to develop personal and/or business relationships. Groups 1620 may be formed by those Members 150 having an interest in the same subjects. Groups 1620 may be private—that is accessible only to a plurality Group Members 1710, which may comprise a collection of Members 150 with a common interest in the subject around which the Group 1620 is formed. Such private Groups 1620 may require Members 150 to take some affirmative action to join the Group 1620 and become Group Members 1710, perhaps by providing some private information and obtaining a username and password, or any other form of electronic identification that will identify Group Members 1710 to each other and provide access to the Group 1620. Alternatively, Groups 1620 may be public, perhaps being accessible to any Member 150.

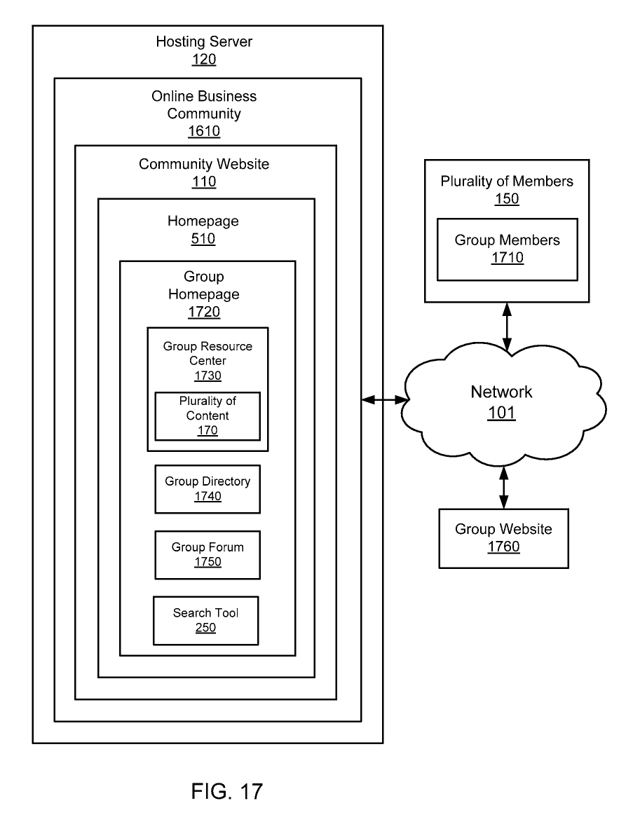

As exemplified in FIG. 17, the Online Business Community's 1610 Community Website 110 may have a Homepage 510 accessible to Members 150 via the Network 101. The Homepage 510 may comprise a link to a Group Homepage 1720, which may provide Members 150 and/or Group Members 1710 with access to the Group 1620 and any associated content and/or functionality. For example, the Group Homepage 1720 may provide links to a Group Resource Center 1730, a Group Directory 1740, and/or a Group Forum 1750. The Group Homepage 1720 also may provide any of the functionality of the Homepage 510 described in detail above including, but not limited to, a Search Tool 250. The Group Homepage 1720 may be private—that is accessible only to Group Members 1710, perhaps by employing password protection or any other electronic security mechanism that is known in the art or may be developed in the future. Alternatively, the Group Homepage 1720 may be public—that is accessible to any Member 150 via the Community Website 110.

The Group Homepage 1720 also may list all Groups 1620 that have been formed in the Online Business Community 1610, perhaps organized by topic, alphabetically, favorite, most popular, or another method. In an example embodiment, links to Groups 1620 may be visible to all Members 150 on the Group Homepage 1720, but only Group Members 1710 may access the links to their Groups 1620. In an alternate embodiment, all Members 150 may be provided access to all Groups' 1620 links.

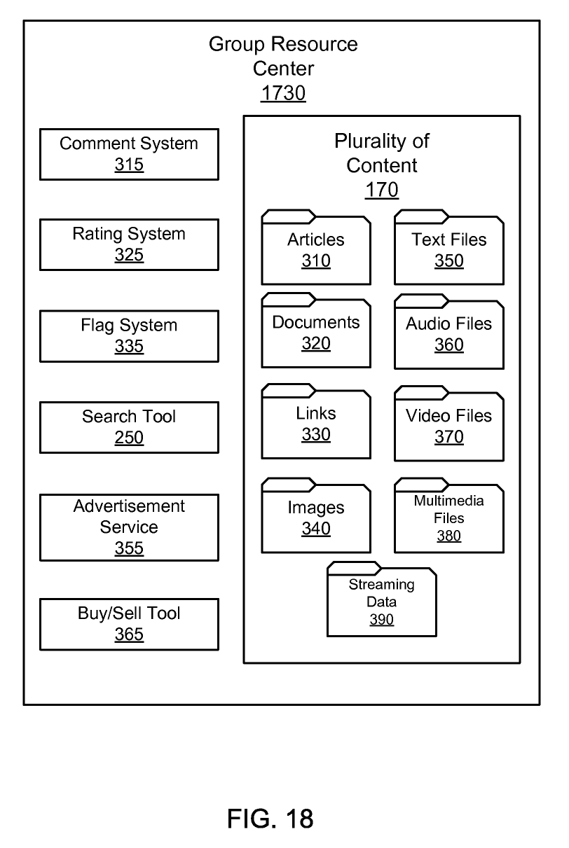

The Group Resource Center 1730 may provide Group Members 1710 access to a plurality of Content 170, some of which may have been generated by Group Members 1710. As shown in FIG. 18, the plurality of Content 170 may comprise a plurality of articles 310, a plurality of documents 320, a plurality of links 330, a plurality of images 340, a plurality of text files 350, a plurality of audio files 360, a plurality of video files 370, a plurality of multimedia files 380, streaming data 390, or any combination thereof. The plurality of Content 170 may include any piece of information that Group Members 1710 may think is useful to other Group Members 1710 including, but not limited to, articles (authored by Group Members 1710 or others), documents in any format (e.g., .doc, .pdf, .tif, etc.), blogs, video clips, audio clips, podcasts, photographs, spreadsheets, flash content, links to other websites, and/or any other resource.

The Group Resource Center 1730 may offer the same functionality as the Resource Center 140 (only on a smaller scale and focused around Group Members' 1710 subjects of interest) and may be implemented with the same technology, which is described in detail above. As with the Resource Center 140, the Group Resource Center 1730 may further comprise a Comment System 315, Rating System 325, Flag System 335, Search Tool, 250, Advertisement Service 355, and/or Buy/Sell Tool 365.

The Group Homepage 1720 also may have a link to a Group Directory 1740, which is a feature allowing Group Members 1710 to generate, post, upload, and/or search a plurality of Business Profiles 410 and a plurality of Individual Profiles 420. It may provide an online location for Group Members 1710 to locate and review information about each other. The Group Directory 1740 may offer the same functionality as the Directory 210 (only on a smaller scale and focused around Group Members' 1710 subjects of interest) and may be implemented with the same technology, which is described in detail above. As with the Directory 210, the Group Directory 1740 may further comprise a Comment System 315, Rating System 325, Flag System 335, Search Tool, 250, and/or Advertisement Service 355.

The Group Homepage 1720 also may have a link to a Group Forum 1750 capable of being written to and read by said plurality of Group Members 1710. Group Forum 1750 is a feature allowing Group Members 1710 to communicate and interact with each other via any online communication method known in the art or developed in the future including, but not limited to, Internet forums (e.g., Web forums, message boards, discussion boards, (electronic) discussion groups, discussion forums, bulletin boards), IM (instant messaging), VoIP (voice over IP), email, blogs, and/or any combination thereof. The Group Forum 1750 may offer the same functionality as the Forum 220 (only on a smaller scale and focused around Group Members' 1710 subjects of interest) and may be implemented with the same technology, which is described in detail above.

Groups 1620 may each be assigned a domain name, such as www.groupname.com, for example. The domain name may be assigned by the Online Business Community 1610, or perhaps Group Members 1710 may request a specific name. Group Members 1710 may use the domain name to develop and/or publish a Group Website 1760, which may be used to promote the interests of the Group 1620 and/or Group Members 1710.

Group Members 1710 also may communicate and collaborate with each other via the tools discussed in detail above including, but not limited to, the Resource Center 140, Directory 210, and Forum 220. Additionally, Groups 1620 may employ calendaring, e-mail, VoIP, IM, and/or Wiki functionality accessible only to Group Members 1710. Group Members 1710 also may be provided with tools (perhaps utilizing Forum 220 functionality) to send out broadcast messages to other Group Members 1710. These messages may appear on public and private webpages, depending on the type of message.

A Method for Providing and Managing Sub-Communities within an Online Business Community

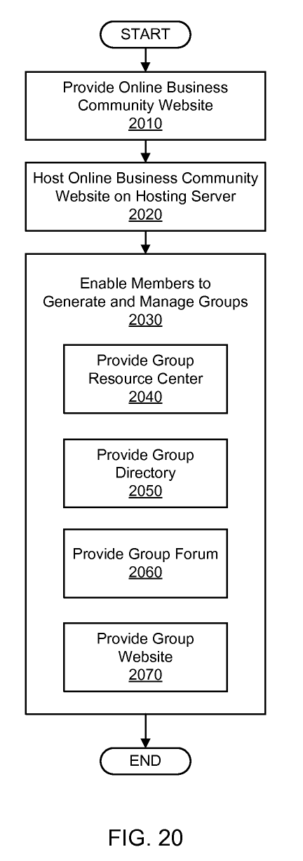

Several different methods may be used to provide and manage sub-communities within an online business community. In an example embodiment illustrated in FIG. 20, a Community Website 110 (accessible to a plurality of Members 150 via a Network 101) is provided (Step 2010) by hosting the Community Website 110 on at least one Hosting Server 120 (Step 2020). This embodiment places no limitation on the individual or entity providing the Community Website 110. Thus, among others, this method may be performed by an individual, entity, automated system, domain name registrar, domain name registry, reseller of a domain name registrar, Internet service provider, software developer, website designer, website operator, or any combination thereof.

The Community Website 110 may be hosted on a Hosting Server 120 by, as a non-limiting example, subscribing to a hosting provider (e.g., GODADDY.COM) for website hosting services (e.g., GODADDY.COM's HOSTING PLANS). Alternatively, the Community Website 110 may be hosted on any computer or program that provides services to other computers, programs, or users either in the same computer or over a computer network including, but not limited to, application, communication, mail, database, proxy, fax, file, media, web, peer-to-peer, or standalone servers.

A plurality of Members 150 then may be enabled to generate and manage Groups 1620 within the Online Business Community 1610 accessible via the Community Website 110 (Step 2030). Members 150 may be enabled to generate and manage Groups 1620 by providing the tools necessary to do so, such as a Group Resource Center 1730 where Members 150 may post a plurality of Content 170 (Step 2040); providing a Group Directory 1740 where Members 150 may post Business Profiles 410 and/or Individual Profiles 420 (Step 2050); providing a Group Forum 220 capable of being written to and read by Members 150 (Step 2060); and/or providing a Group Website 1760 (Step 2070), which may be accomplished by providing Members 150 with a domain name and an companying Group Website 1760 for Members 150 and/or Group Members 1710 to promote their interests. The Group Website 1760 may resolve from a domain name that was assigned to the Group 1620, or perhaps requested by Members 150 or Group Members 1710. These tools may be provided by installing the machine-executable software 910 described throughout this application necessary to implement the Resource Center 140, Directory 210, and/or Forum 220 on any server communicatively coupled to a Network 101.

A System for Designating Membership in an Online Business Community

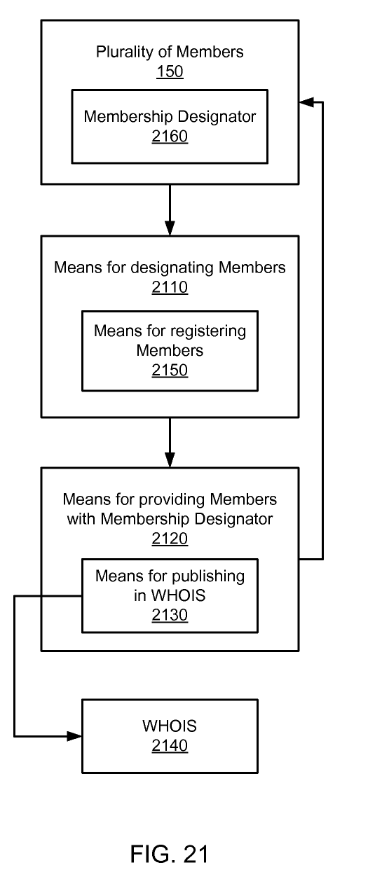

FIG. 21 illustrates an example embodiment of a system for designating membership in an online business community. The illustrated embodiment includes means for designating 2110 a plurality of Members 150 as participants in an Online Business Community 1610 and means for providing 2120 each of said plurality of Members 150 with a Membership Designator 2160. The Online Business Community 1610 may comprise any virtual community, online community, or e-community that allows Members 150 to interact online that relates in any manner to business. The Online Business Community 1610 may comprise any of the communities described above, or such others that are known in the art or may be developed in the future.

The means for designating 2110 provides identification for those Internet users who become Members 150 of the Online Business Community 1610 and, therefore, may wish to identify themselves and/or their domain name, URL, website, e-mail address, and/or any combination thereof as connected to the Online Business Community 1610. The means for designating 2110 may comprise any system that allows Internet users to become characterized as Members 150 including, but not limited to, systems that identify all visitors to the Community Website 110 as Members 150, systems that allow any Internet user to sign up as a Member 150, or systems that select as Members 150 only those Internet users that meet certain criteria.

Alternatively, the means for designating 2110 may comprise means for registering 2150 Members 150 having the ability to collect one or more pieces of information from each of said plurality of Members 150, said information comprising, as non-limiting examples, a domain name, a URL, an e-mail address, a website, and/or any combination thereof owned and/or controlled by said Member 150. Thus, the means for registering 2150 may require those Internet users who wish to become Members 150 to sign up, perhaps via a pop-up window (or redirection to another webpage) that appears on the Community Website 110 that allows Internet users to enter information and become registered Members 150. They may obtain a password and username thereby enabling future access to the Online Business Community 1610. Alternatively, Single Sign-On (SSO) functionality may be enabled allowing properly-authenticated Members 150 access to the Online Business Community 1610.

Regardless of the membership criteria, the means for designating 2110 also may comprise a membership database communicatively coupled to a Network 101 that maintains a list of Members 150 and any associated information that such Members 150 may provide, including, but not limited to their name, address, telephone number, domain name, URL, website, e-mail address, and/or any combination thereof. Structurally, the membership database may comprise any collection of data, including any of the database types discussed in detail above.

Possibly using information in the membership database, the means for providing 2120 Members 150 with a Membership Designator 2160 may provide Members 150 with a Membership Designator 2160. A Membership Designator 2160 indicates that an item (e.g., domain name, URL, website, e-mail address, and/or any combination thereof) is owned, operated, maintained, provided, and/or somehow associated with a Member 150 of the Online Business Community 1610. A Membership Designator 2160 may take the form of a displayable image; a link to the Online Business Community 1610; an invitation to join the Online Business Community 1610; a certificate for display on a website; a change in appearance of a Member's 150 domain name, URL, e-mail address, website, and/or any combination thereof; an audible sound; and/or any combination thereof.

Means for providing 2120 Members 150 with a Membership Designator 2160 may include, but are not limited to: (1) sending a piece of software to the Member 150 (or other individual or entity) for installation on his computer, server, website, database, or other storage device; (2) storing the Membership Designator 2160 on a computer, server, website, database, or other storage device from which the Member 150 (or other individual or entity) may retrieve the Membership Designator 2160; or (3) sending the Membership Designator 2160 to a third party for storage on a computer, server, website, database, or other storage device from which the Registrant 100 (or other individual or entity) may retrieve and/or view said Membership Designator 2160. The Membership Designator 2160 may be sent utilizing any method of transferring data known in the art as defined in detail above, or as may be developed in the future.

Where the Online Business Community 1610 Hosting Entity 130 is a domain name registry, registrar, or other entity with the ability to access and edit WHOIS records 2140, the means for providing 2120 Members with a Membership Designator 2160 may comprise means for publishing 2130 the Membership Designator 2160 in WHOIS records 2140. WHOIS is a TCP-based query/response protocol that is widely used for querying a database in order to determine the owner of a domain name, an IP address, or an autonomous system number on the Internet. WHOIS records may be maintained by a registry, a registrar, and/or another party. “Thin” registries store limited amount of information about a domain name; typically, it includes the domain Name, registrar, WHOIS server, referral URL, name server, status, updated date, creation date, expiration date, etc. “Thick” registries in addition store registrant, administrative, technical, and billing contact information. Registrars usually store detailed information about the domain names registered through them.

The WHOIS system originated as a method that system administrators could use to look up information to contact other IP address or domain name administrators. The use of the data that is returned from query responses has evolved from those origins into a variety of uses. In the illustrated embodiment, the means for publishing 2130 may publish a Membership Designator 2160 in the WHOIS Records 2140. As with Membership Designators 2160 provided to Members 150, the published Membership Designator 2160 may take the form of a displayable image; a link to the Online Business Community 1610; an invitation to join the Online Business Community 1610; a certificate for display a website; a change in appearance of a Member's 150 domain name, URL, e-mail address, website, and/or any combination thereof; an audible sound; and/or any combination thereof.

A Method for Designating Membership in an Online Business Community

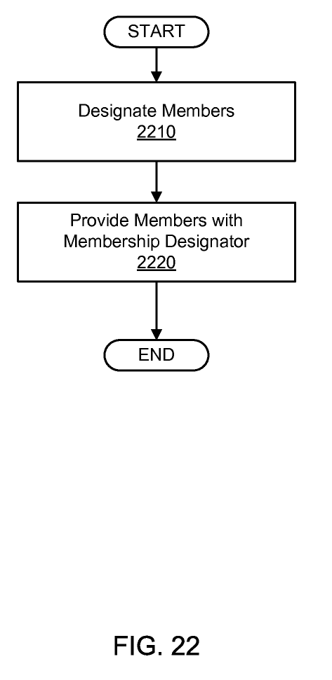

Several different methods may be used to designate membership in an online business community. In a streamlined example embodiment illustrated in FIG. 22, a plurality of Members 150 are designated as participants in an Online Business Community 1610 (Step 2210). Each Member 150 is then provided with a Membership Designator 2160. (Step 2220). These steps may be accomplished with the means for designating 2110 a plurality of Members 150 as participants in an Online Business Community 1610 and means for providing 2120 each of said plurality of Members 150 with a Membership Designator 2160 discussed in detail above.

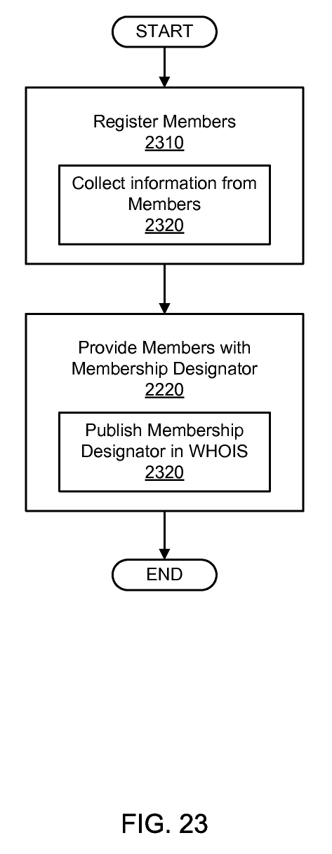

A more detailed example embodiment of a method for designating membership in an online business community is illustrated in FIG. 23, in which the designating step (Step 2210) further comprises the step of registering said plurality of Members 150 (Step 2310). The registering step (Step 2310) also may comprise the step of collecting one or more information from each of said plurality of Members 150 (Step 2320), said information comprising a domain name, a URL, an e-mail address, a website, and/or any combination thereof owned and/or controlled by said Member 150. These steps may be accomplished with the means for designating 2110 a plurality of Members 150 as participants in an Online Business Community 1610 and means for registering 2150 Members 150 discussed in detail above. Alternatively, the providing step (Step 2220) may be accomplished by publishing the Membership Designator 2160 in the WHOIS records 2140 associated with each of said plurality of Members 150 (Step 2320). As set forth in detail above, this step may be accomplished via means for publishing 2130 the Membership Designator 2160 in WHOIS records 2140.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system, comprising:
a) a Community Website hosted on at least one Hosting Server communicatively coupled to a Network;
b) a Resource Center accessible to a plurality of Members via said Community Website, said Resource Center providing access to a plurality of Content wherein at least some of said plurality of Content is generated by at least one of said plurality of Members;
c) a Directory accessible to said plurality of Members via said Community Website, wherein said Directory comprises a plurality of Business Profiles wherein at least some of said plurality of Business Profiles are generated by at least one of said plurality of Members, and a plurality of Individual Profiles wherein at least some of said plurality of Individual Profiles are generated by at least one of said plurality of Members;
d) a Forum capable of being written to and read by said plurality of Members, said Forum being accessible to said plurality of Members via said Community Website;
e) a Business Portal configured to allow a plurality of authenticated Members to manage at least one Business Tool, said Business Portal being accessible to a plurality of properly-authenticated Members via said Community Website; and
f) a Content Management System configured to manage content on said Community Website.

2. The system of claim 1, wherein said Community Website is password protected.

3. The system of claim 1, wherein said plurality of Content comprises a plurality of articles, a plurality of documents, a plurality of links, a plurality of images, a plurality of text files, a plurality of audio files, a plurality of video files, a plurality of multimedia files, or a streaming data.

4. The system of 3, wherein said Resource Center further comprises a Comment System.

5. The system of 4, wherein said Resource Center further comprises a Rating System.

6. The system of 5, wherein said Resource Center further comprises a Flag System.

7. The system of 6, wherein said Resource Center further comprises a Search Tool.

8. The system of 7, wherein said Resource Center further comprises an Advertisement Service.

9. The system of 8, wherein said Resource Center further comprises a Buy/Sell tool.

10. The system of claim 1, wherein said Directory further comprises a Comment System.

11. The system of claim 10, wherein said Directory further comprises a Rating System.

12. The system of claim 11, wherein said Directory further comprises a Flag System.

13. The system of claim 12, wherein said Directory further comprises a Search Tool.

14. The system of claim 13, wherein said Directory further comprises an Advertisement Service.

15. The system of claim 14, wherein said Directory further comprises a Buy/Sell tool.

16. The system of claim 1, wherein said Business Portal further comprises a Business Portal Webpage on said Community Website

17. The system of claim 16, wherein said at least one Business Tool comprises a website management tool, a private communication system management tool, a blog management tool, a forum management tool, a domain name management tool, an inventory management tool, a shared file management tool, a calendar tool, or a SSL certificate management tool.

18. The system of claim 1, further comprising a Partnership Tool allowing said plurality of Members to establish at least one partnership with others of said plurality of Members, said Partnership Tool being accessible to said plurality of Members via said Community Website.

19. The system of claim 1, further comprising a Member Reputation System having the ability to establish and publish a Member Trust Level.
